(19) United States
(12) Patent Application Publication
(10) Pub. No.: US 2023/0311321 A1
(43) Pub. Date: Oct. 5, 2023

(54) Collaborative Robot System Incorporating Enhanced Human Interface

(71) Applicants: Zac Bogart, Santa Barbara, CA (US); Rodney Martinez, Ojai, CA (US); Jacob Beahan, Goleta, CA (US); Charlie Thomson, Ventura, CA (US)

(72) Inventors: Zac Bogart, Santa Barbara, CA (US); Rodney Martinez, Ojai, CA (US); Jacob Beahan, Goleta, CA (US); Charlie Thomson, Ventura, CA (US)

(73) Assignee: Productive Robotics, Inc., Carpinteria, CA (US)

(21) Appl. No.: 18/135,429

(22) Filed: Apr. 17, 2023

Related U.S. Application Data
(63) Continuation of application No. 16/981,194, filed on Sep. 15, 2020.

(51) Int. Cl. B25J 9/16; B25J 9/08

(52) U.S. Cl. CPC B25J 9/1666; B25J 9/163; B25J 9/08; B25J 9/1656; G05B 19/423

(57) ABSTRACT

A robot system useful in manufacturing environments for diverse applications. The system is characterized by an elongate robot arm operable to selectively position an end effector. The robot arm is configured for movement by a CPU based control system and/or by physical manipulation by a human operator.

This application is a Continuation of U.S. application Ser. No. 16/981,194 filed 15 Sep. 2020 and entitled to a priority date of Mar. 27, 2018 as a consequence of PCT/US18/24662.

### FIELD OF THE INVENTION

The present invention is directed to robot systems useful in manufacturing environments for diverse applications, such as:
Loading, Unloading and Part Removal
Machine Tending and Batch Production
Gluing, Painting and Welding
Polishing, Cutting, Deburring and Grinding
Packaging and Palletizing
QC Measuring, Testing, and Inspection
   More particularly, the invention is directed to a class of robots known to the industry as “Collaborative Robots” which are intended to operate safely in close proximity to humans and which can be readily operated and programmed by human operators.

### BRIEF SUMMARY OF THE INVENTION

Systems in accordance with the invention are characterized by an elongate robot arm operable to selectively position an end effector. The robot arm is configured for movement by a CPU based control system and/or by physical manipulation by a human operator.

In a preferred embodiment, the robot arm is comprised of multiple, e.g. 7, joint modules arranged in series including an initial module, intermediate modules, and a final module configured to carry said end effector.

Systems in accordance with the invention emphasize programming by physical interaction with the robot arm involving tactile and manual manipulation of the arm facilitated by visual and auditory feedback from the arm. Instead of employing text based computer code or complicated tree structures, the system constructs its internal programming in response to physical manipulations of the robot arm by the operator during a process referred to as a “learning” mode. Separate programs created during the learning mode are referred to as “jobs” which define a sequence of steps to be executed by the arm. The internal programming for the jobs can be inferred from the physical manipulations of the robot arm during the “learning” process. Subsequent to the robot's learning of a job, a job can be edited by means of either physical manipulation, or alternatively by editing of data presented on a system input/output device, e.g., a touch screen computer tablet. Adjustments to a job program can be made both while learning and while performing a job, by pushing, tapping, or slapping the robot arm itself. Physical motion paths trajectories can be refined by forcefully redirecting the movement of the robot arm as it moves through its initially learned paths. Fine adjustments to the arm's position can be affected by physical “tapping” which the control system interprets into small incremental adjustments in position. Alternatively, physical manipulation of the position and attitude can be implemented via the input/output device.

In accordance with a significant feature of the invention, when the robot arm is idle, it is kept in a limber compliant state such that a human operator can directly physically move the arm without the actuation of computer controls. In such cases, the system remembers and can slowly and safely return the arm to its idle state position when the interaction with the human operator ceases.

In a preferred system embodiment, feedback to a human operator is made by visual and/or auditory means. Joint modules in the robot arm carry status indicator devices, e.g. multicolor LEDs, to indicate joint status and condition. The color and consistency of the illumination indicate the robot's operating mode as well as confirming the receipt of physical input from the human operator. In some circumstances, auditory feedback is issued from a joint module, as, for example, by creating small physical oscillations of a joint motor.

Preferred systems in accordance with the invention are additionally characterized by one or more of the following features:
1—A robot arm comprised of multiple joint modules including active status indicators, e.g., multi-color LEDs, for indicating the status and current operating condition of the joint modules.
2—A robot arm including impact sensors, e.g., accelerometers, for sensing small taps by a human operator for incrementally repositioning the arm.
3—Means for controlling joint motors to establish an idle state, i.e., a defined positioning of the joints, which the system can return to after physical displacement.
4—A method of editing a robot arm trajectory while being executed by physical manipulation of the arm.
5—A method of programming a robot arm in a learn mode by allowing a human operator to physically move the arm to establish physical destination points.
6—A method of using an I/O device, e.g. a tablet, to control a central processor to create a job program, e.g., a sequence of pick and place destination points.

In accordance with a further aspect of the invention, the robot system is configured so that it can be readily relocated for use in a different area of a facility without sacrificing registration setup parameters and without need of rebooting and reprogramming the system electronics. The foregoing is achieved by providing a mobile platform or stand including a rigid chassis (hereinafter “frame”) supported on wheels. The frame includes a robot arm proximal end. Additionally, the frame preferably further includes a table mounting structure offering a horizontal work surface. The work surface is preferably equipped with multiple mounting points for referencing the location of various fixtures, etc. so that the entire assembly can be relocated without disturbing the relationship between the robot arm and objects to be handled. To further enhance the utility of the platform, shelves and/or components are preferably provided for accommodating electronic equipment, e.g., power supply, system computer, etc. to enable the robot system to be quickly operational after movement to a new location.

### BRIEF DESCRIPTION OF THE FIGURES

FIG. 1. Is a block diagram of a preferred robot system in accordance with the present invention.

FIG. 2 is a perspective view of a preferred robot arm comprised of multiple joint modules and schematically illustrating light emitting status indicators associated with the modules.

FIG. 3 is a perspective view of a single joint module schematically depicting a light emitting area and also the motion of an output rotary actuator;

FIG. 4 is a block diagram depicting preferred components of a joint module;

FIG. 5 is a flow chart depicting the operation of a light emitting status indicator;

FIG. 6 depicts a preferred I/O device, i.e. a tablet, for assisting operator control of the robot system;

FIG. 7 depicts the simplified generation of a robot program employing the tablet of FIG. 6;

FIG. 8 depicts the control tablet of FIG. 6 employing various tilt and rotation movements for controlling movement of the robot arm and/or end effector;

FIG. 9 depicts exemplary rotations of the end effector in response to movements of the control tablet represented in FIG. 8;

FIG. 10 is a flow chart of the control logic employed by the system computer in response to the movement of the control tablet as shown in FIG. 8;

FIG. 11 depicts a human operator tapping a joint module;

FIGS. 12A and 12B is a flow chart of the control logic employed by the system computer in response to the tapping of a joint module represented in FIG. 11;

FIG. 13A depicts a human operator moving the robot arm while in idle mode and FIG. 13B depicts the robot arm returning to its rest position;

FIG. 14 is a flow chart of the control logic employed by the system computer in response to the manual human manipulation of the robot manipulator while in idle mode;

FIG. 15 depicts a human operator manipulating the robot arm while teaching operations and movements;

FIG. 16 depicts a preferred control handle for use by an operator;

FIG. 17A is a flow chart of the procedure executed by the system computer as it automatically builds a program in response to the movement of the robot arm and the designation of important positions of the arm;

FIG. 17B is a flow chart of the logic employed by the system computer as it automatically builds the portion of the program which acquires (picks) objects to be moved by the robot arm;

FIG. 17C is a flow chart of the logic employed by the system computer as it automatically builds the portion of the program which places objects which have been acquired by the robot arm;

FIG. 18 shows the control tablet as the program is being automatically constructed in response to the manipulation of the robot arm by a human operator;

FIG. 19 depicts a human operator slapping a joint module on the robot arm to signal acknowledgement;

FIG. 20 is a flow chart of the logic employed by the system computer to interpret the tapping or slapping by the human operator;

FIG. 21 depicts robot joints emitting sounds;

FIG. 22 shows the robot arm executing a robot program while a human operator forcefully alters the trajectory of the moving arm;

FIG. 23 is a flow chart of the control logic employed by the robot computer to record the modification of the robot movement trajectory programming;

FIG. 24 is an isometric view of an assembly comprised of the aforedescribed robot system mounted on a mobile platform;

FIG. 25 is an enlarged view of the end effector aligning with a reference point on the table work surface;

FIG. 26 is a side view of the robot and platform mounting structure;

### DETAILED DESCRIPTION

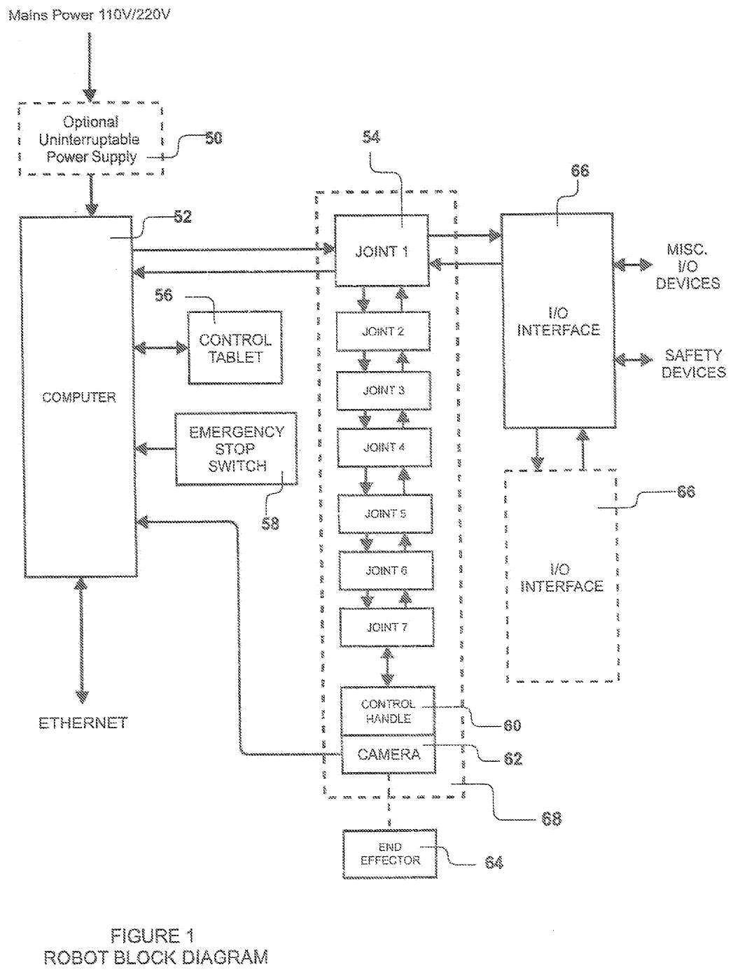

FIG. 1 is a block diagram of a robot system in accordance with the invention comprised primarily of a robot arm 68 and a control system including computer 52. The elongate arm 68 is comprised of multiple joint modules 54 coupled in series and including an initial module (joint 1) at the arm proximal end, one or more intermediate modules, and a final module (joint 7) at the arm distal end. The preferred embodiment described herein employs seven joint modules but it should be understood that a lesser or greater number of joint modules can be used. The preferred arm 68 of FIG. 1 can also advantageously include a control handle 60 and a camera 62 mounted proximate to the final module joint 7 at the distal end of arm 68. The arm distal end is configured to also mount an end effector 64, typically a gripper, by, for example, attaching it to the camera 62, the control handle 60, or final module 54 (joint 7).

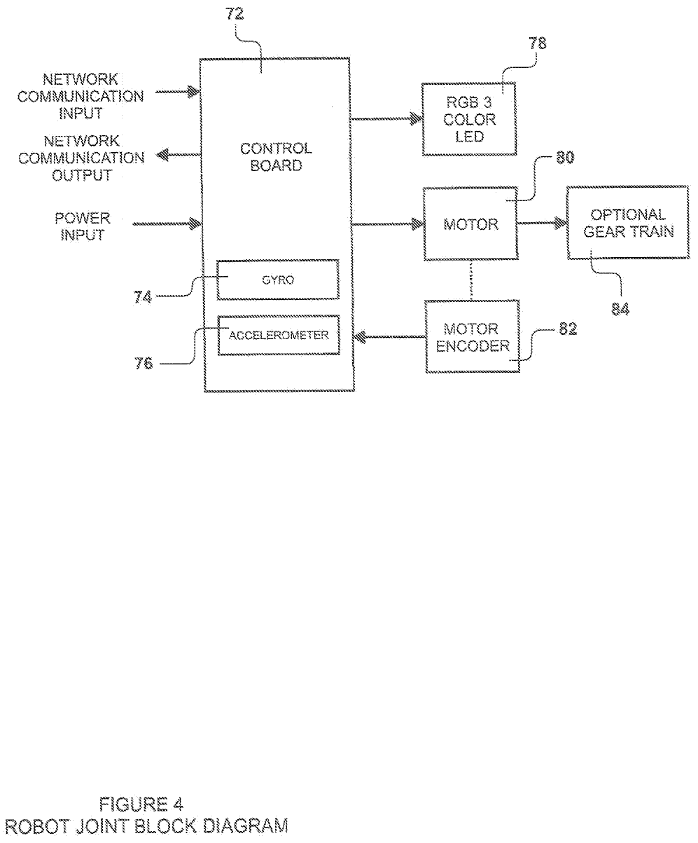

As seen in FIG. 4, each joint module 54 in the preferred embodiment includes a motor 80 for driving a rotary actuator, for example, the output of a gear train 84. The control computer 52 is electrically coupled to the various arm components including joint control boards 72, handle 60, and camera 62 and preferably also communicates with an I/O device, e.g. control tablet 56 and emergency stop switch 58, for example, via a serial communication channel and protocol. The I/O interfaces 66 optionally provide connections to external equipment for the purpose of control and synchronization with the robot arm 68 as it performs its programmed tasks. The control computer 52 preferably contains the power supply necessary to the power the robot arm components, although it is possible for that power supply to be physically separated from the control computer. An optional uninterruptible power supply 50 of a type commonly used for desktop computers can be installed between the mains power and the control computer 52, provided it is of sufficient capacity to power the computer and robot arm modules for a sufficient period of time. Ordinarily, the uninterruptible power supply 50 is operational only while the robot system is being physically relocated to avoid having to reboot the control computer 52 at its new location. The control computer 52 may optionally be connected to a local computer network, to allow monitoring, or transmission of operational data to external computer systems.

All the joint modules are substantially identical in contents, although they may be of differing sizes. FIG. 4 is a block diagram showing the electrical components of an exemplary joint module 54 including a control board 72 for receiving power and command communications, as well as sending operational data via a network connection. The control board 72 preferably includes a gyro 74 and an accelerometer 76. Connected to the control board 72 are: a 3 color status indicator 78, a motor 80 for driving a rotary actuator, e.g. the output of gear train 84, and a motor encoder 82 for reporting position of the motor 80 to the control board 72. The motor 80 drives the rotary actuator 84 to physically rotate the joint module 54 via engagement with flange 70, relative to an adjacent joint.

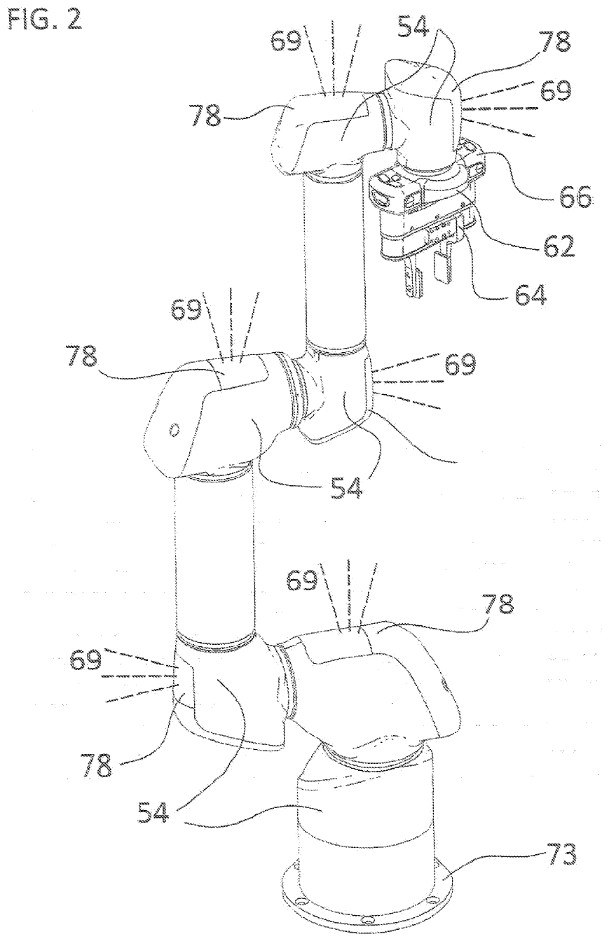

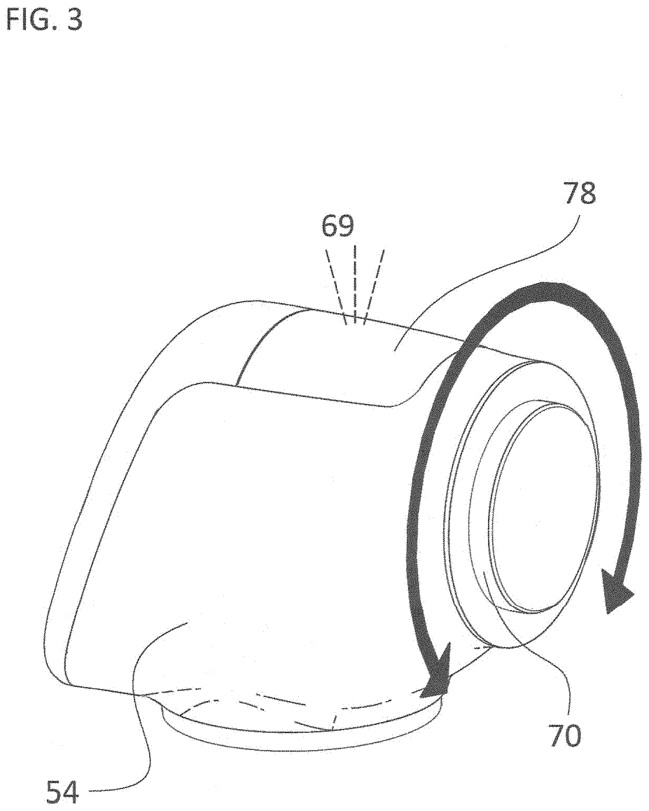

FIG. 2 depicts a preferred physical embodiment of the robot arm 68 showing a base member 73 supporting the initial joint module at the proximal end. Radiating lines 69 are shown emanating from a joint module status indicator 78. The color and intensity of the illumination 69 can be individually controlled via the control board 72 from the control computer 52 to indicate the current operating status to a human operator, e.g.,

| | |
|---|---|
| White Flashing: | Special Function or notification |
| Solid Blue: | Idle |
| Solid Green: | Collaborative Running |
| Pulsing Green: | Collaborative Paused |
| Solid Orange: | Non-collaborative Running |
| Pulsing Orange: | Non-collaborative Paused |
| Flashing Red: | Error |

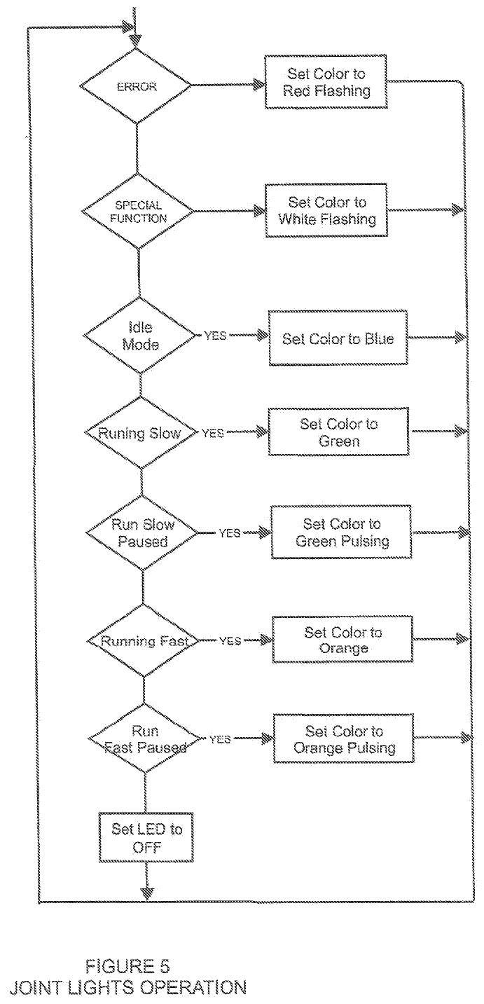

Typically, in operation, all of the joint status indicators 78 will exhibit the same color but in some applications, individual joints may be illuminated differently in order to alert an operator to a particular condition, for example, when one joint is rotated close to its travel limit. FIG. 5 illustrates the control logic which determines the color and state of the illumination in each joint status indicator 78.

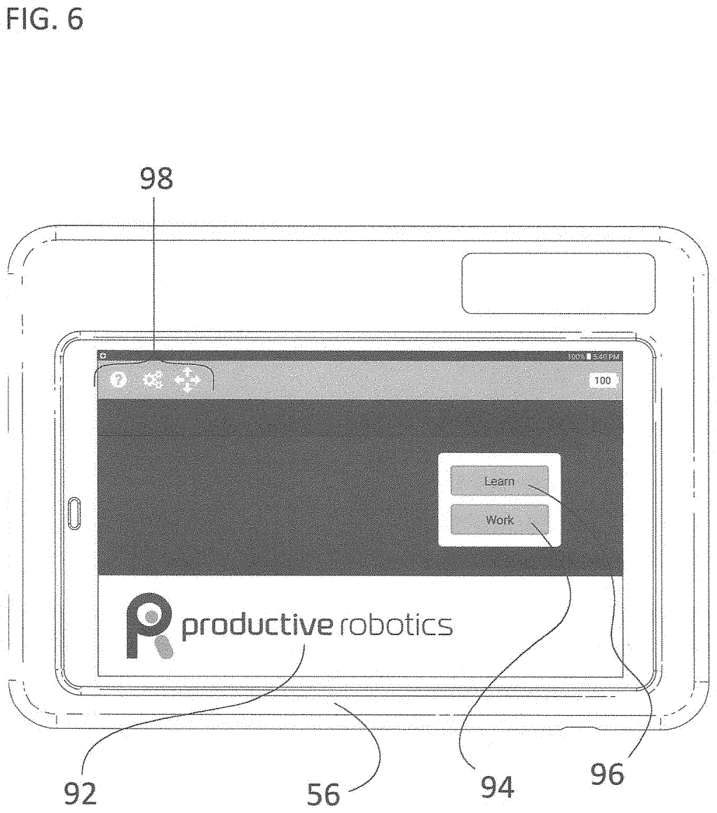

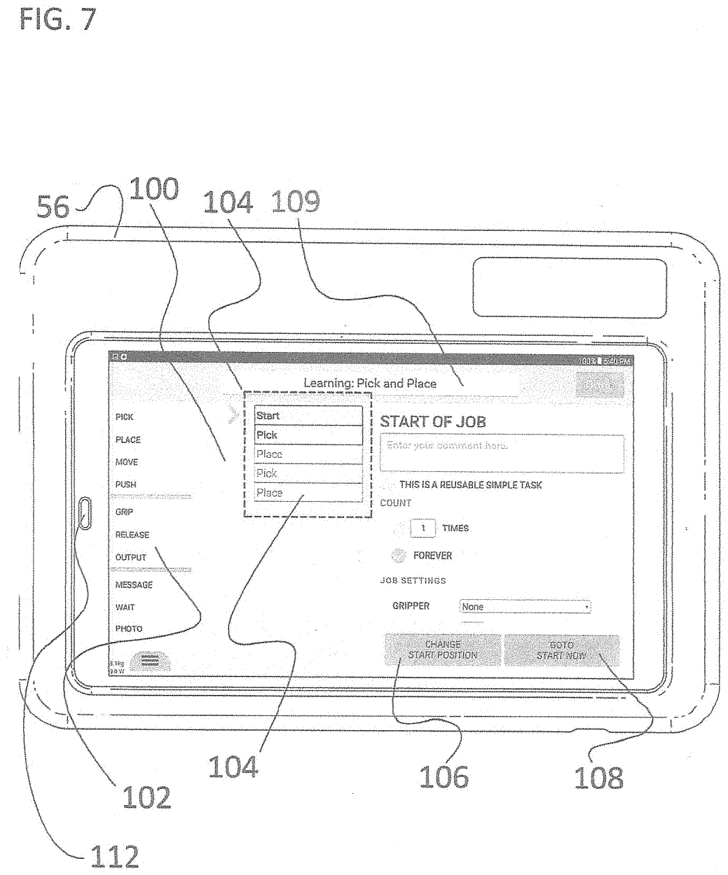

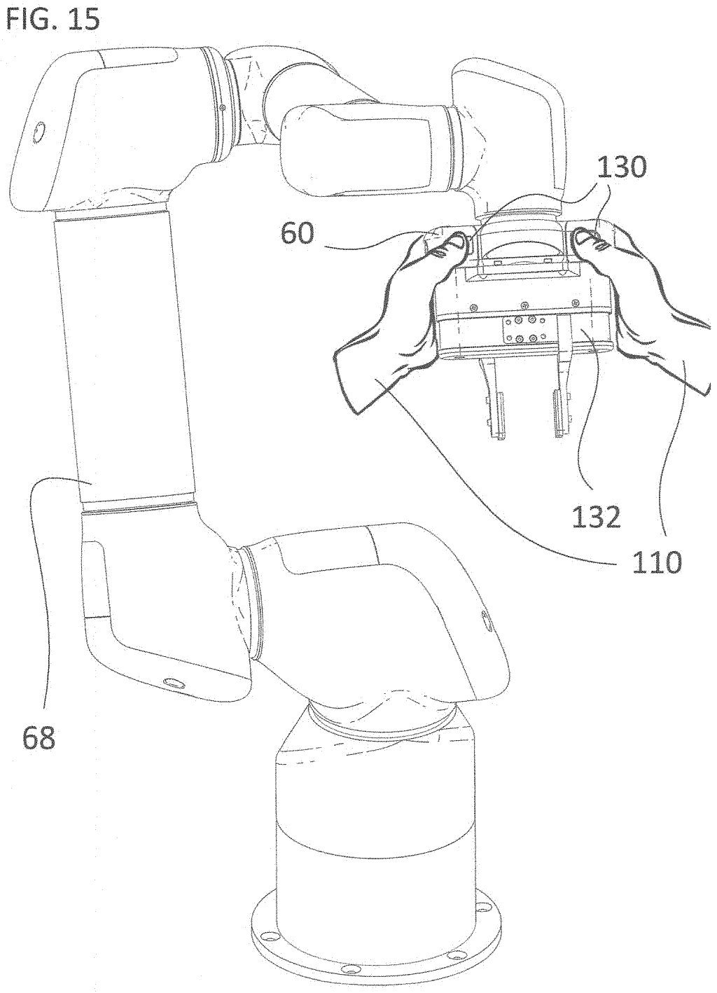

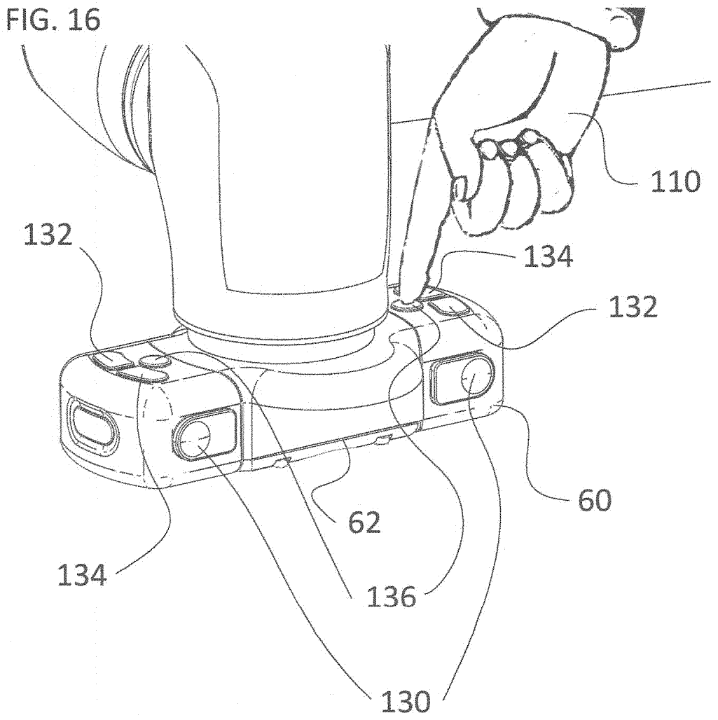

FIG. 6 shows a preferred I/O device 56, preferably a touch screen control tablet. A primary goal of systems in accordance with the invention is to simplify the operation and programming. Accordingly, the primary display 92 on the tablet 56 preferably displays a limited number of functions. The Idle state display on the tablet preferably shows only two primary operations: “Learn” 94 and “Work” 96. Common icons 98 to access some ancillary functions are located in the corner of the tablet. Tapping either of the buttons for Learn 94 or Work 96, or the icons 98 for the ancillary functions, will cause the display on the tablet to change providing access to the corresponding function. FIG. 7 shows the robot control tablet 56 displaying the screen for the learning operation 100. Function “tiles” 102, 104 as shown represent activities of the robot that are performed sequentially from top to bottom. Function tiles may direct simple tasks such as closing a gripper, or more complex tasks such as packing an entire carton of objects. Available functions for use within a robot job are shown in a column 102 on the left hand size of the screen. Function tiles may be added to a job manually, by “dragging” a tile from the left hand column and “dropping” it within the function tiles corresponding to the robot's job 104. Function tiles are alternatively added to the robot job in response to the physical motions of the robot as manipulated by the operator as shown in FIG. 15 and the actuation of functions FIG. 16 using the buttons on the control handle 60, during learning,

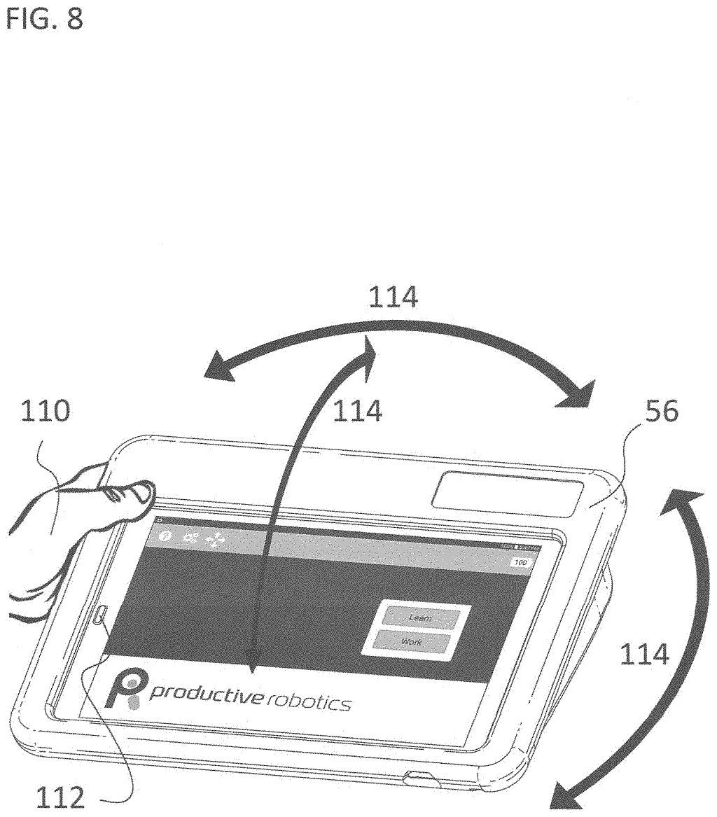

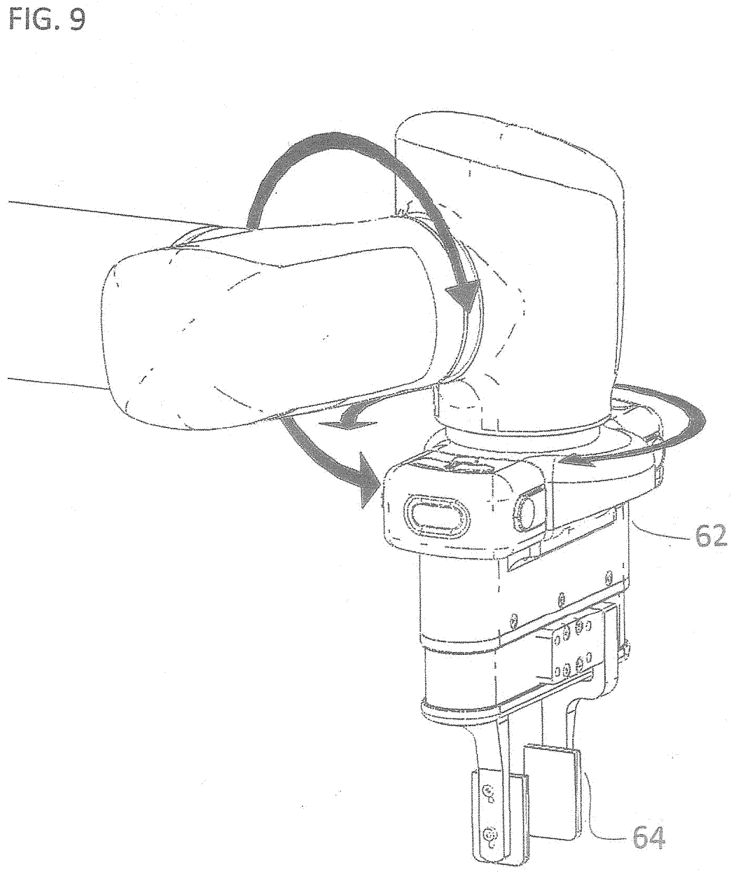

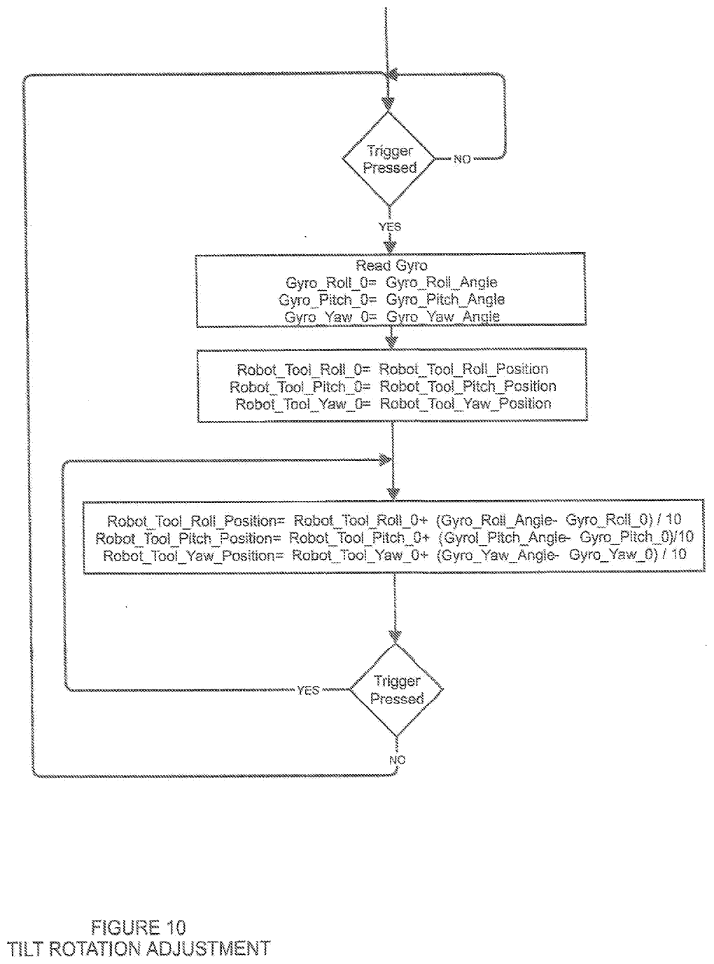

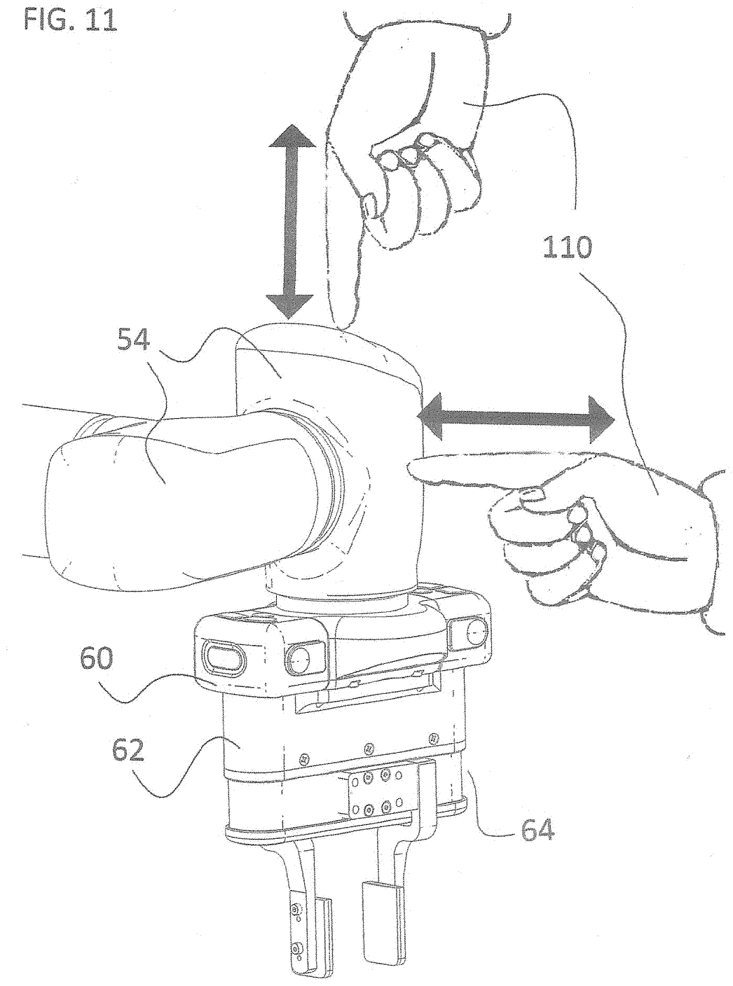

FIG. 8 shows the control tablet 56 being tilted and rotated by a human operator 110 for the purpose of affecting the position and orientation of the distal end of the robot arm. Depressing a trigger button 112 on the tablet activates the control mode making the robot arm responsive to the physical movements of the control tablet. Releasing the trigger button 112 prevents the robot from being responsive to the physical movements of the control tablet. FIG. 9 illustrates the movements of the distal end of the robot arm in response to the physical movements of the control tablet 56 while the trigger button 112 is depressed. FIG. 10 is a flow chart of the control algorithm used by the control computer 52 for directing the motion of the distal end of the robot arm in response to the motions of the control tablet 56. At the instant that the trigger button 112 is depressed, an accelerometer and a gyro in the control tablet 56 are read by the control computer 52. The roll and pitch positions of the tablet reported by the accelerometer, and the yaw position reported by the gyro, are recorded. Changes in orientation 114 of the tablet are measured by the difference between tablet orientation 114 when read from the accelerometer 76 and gyro 74, and the initial roll, pitch and yaw positions which were read at the time the trigger button 112 was depressed. For the purpose of precise positioning of the robot end-effector 64, the physical movements of the control tablet 56 are attenuated before being applied. In the preferred embodiment of the invention, 1/10 of the movement 114 of the control tablet 56 is applied to the distal end of the robot arm 68. For greater movements, the attenuation factor can be decreased. For smaller movements of the end-effector, the attenuation factor can be increased.

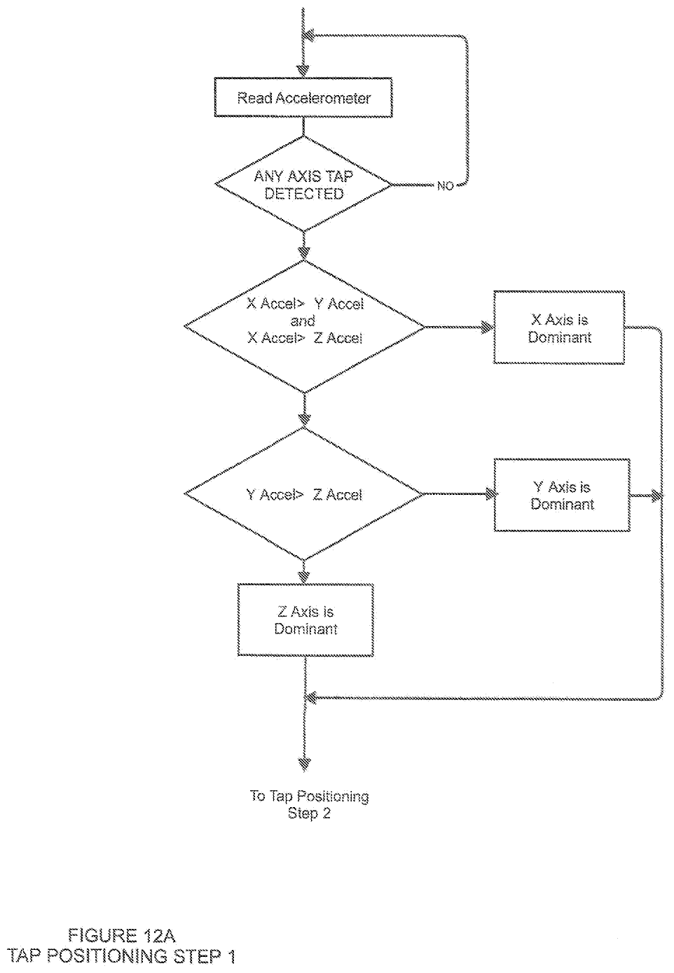

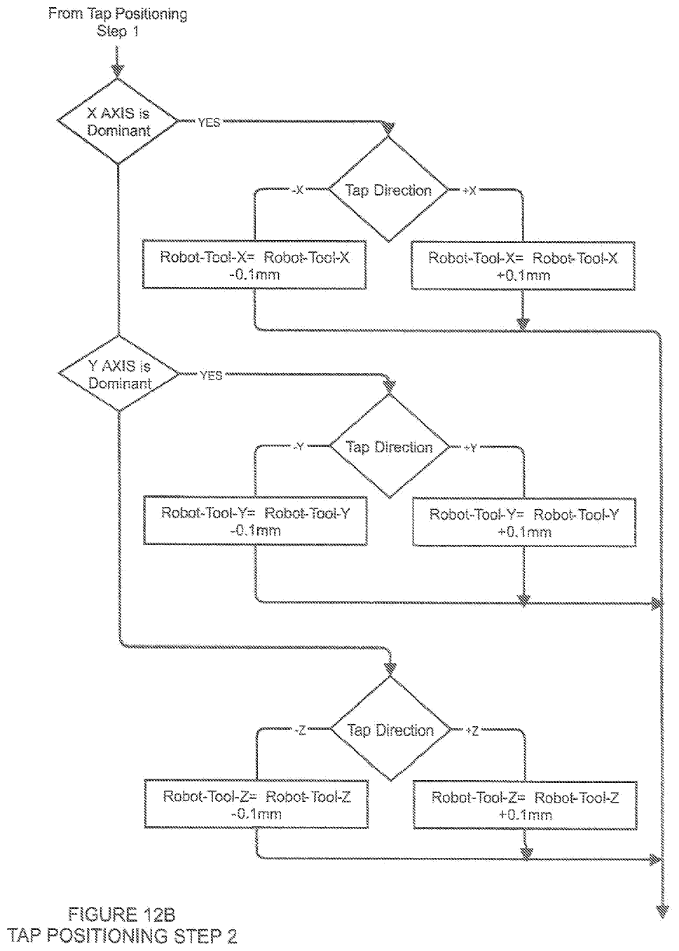

FIG. 11 shows the distal end of the robot arm 68 being tapped by a human operator 110. FIGS. 12A and 12B are a flow chart of the control algorithm used by the control computer 52 to affect small movements of the robot end-effector 64 in response to impacts, ie. taps, sensed when the operator 110 taps one of the robot joints 54. Taps are sensed by the accelerometers 76 located on the control board 72 within each joint module 54 (FIG. 4). The accelerometer 76 reports the amplitude of impacts detected to the control computer 52. Impacts are reported independently in X, Y and Z axes. Impacts below a threshold are discarded. In practice, impacts to the robot joints 54 can cause the joint to vibrate in multiple axes simultaneously. Accelerometer readings will show impacts in all three axes simultaneously. The amplitude of the measured impacts in each axis are compared and the axis reporting the highest amplitude is considered to be the dominant axis. The readings from the remaining two axes are discarded. Next, the direction of the impact in the dominant axis is determined. The sign of the derivative of the acceleration for the dominant axis is evaluated. A positive sign, e.g. rising edge of the acceleration, is a consequence of a tap toward the positive direction of the dominant axis. A new axis target position is calculated by adding 0.1 mm to the target position of the dominant axis. The distal end of the robot arm 68 is then commanded to move to the newly calculated coordinate position. It should be noted that in a robot arm 68 consisting of a series string of revolute joints 54, such as in the preferred embodiment, movements along Cartesian axes require coordinated movements of the revolute joints 54. A process known to those ordinarily skilled in the art, called an “inverse kinematic calculation”, must be performed. The inverse kinematic calculation takes as input the desired Cartesian coordinates of the distal end of the robot arm, and calculates the individual positions of each revolute joint 54 that are required in order to position the distal end of the robot arm 68 in the required Cartesian position. After moving the robot arm 68 to the new Cartesian position, the process is repeated: waiting for another tap to be detected by the accelerometer 76. In alternative embodiments of the invention, it is possible to combine the readings of accelerometers 76 from multiple joints 54 to detect the direction of the taps with greater precision. Such greater precision allow the distal end of the robot arm 68 to be commanded to move in a simultaneous combination of Cartesian directions.

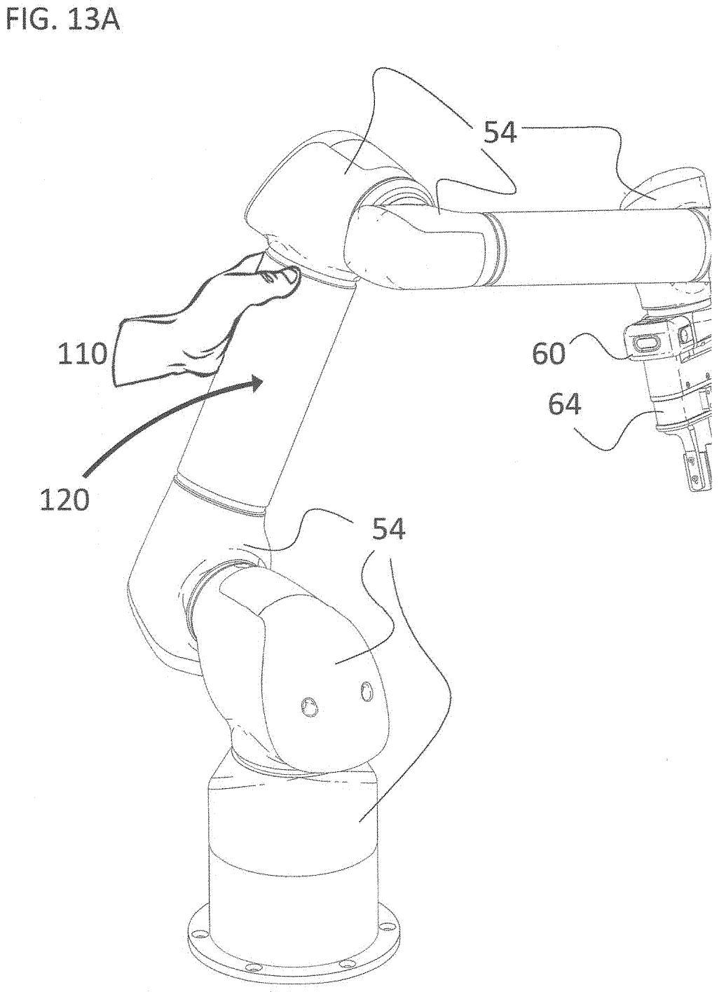

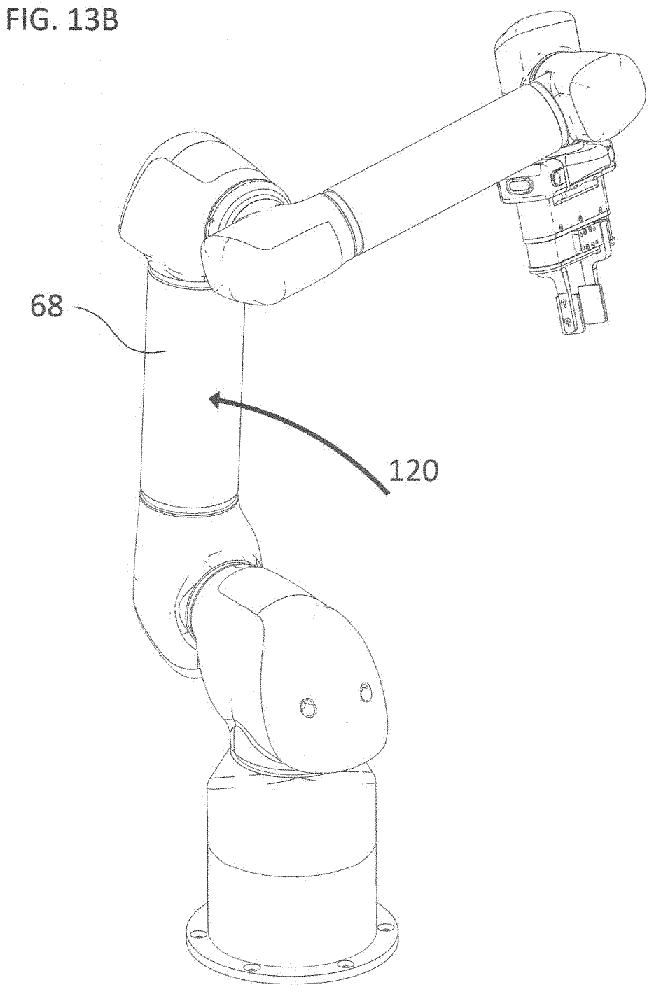

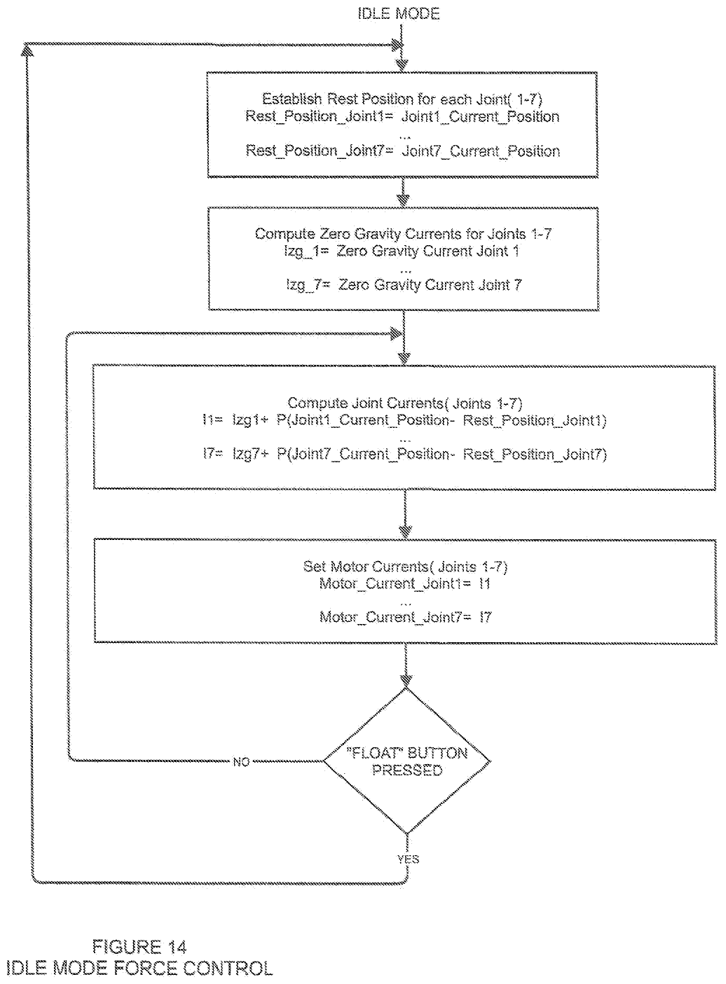

FIG. 13A shows the manual movement of the robot arm 68, by a human operator 110 while it is in the idle state. In this state, all of the joints 54 in the arm are powered to the extent necessary to balance all joints 54 comprising the robot arm 68 against the effect of gravity, preventing any segment in the robot arm 68 from falling or moving without the application of external forces. The currents required to be applied to each joint's motor 80 are normally called “Zero G” currents. The required calculations and application of Zero G currents to the motors 80 in the joints 54 are well known to anyone ordinarily skilled in the art. In the present invention, the application of such Zero G currents to the motors 80 of the joints 54 are utilized. In this idle state, the robot arm 68 may be easily displaced 120 from its resting position by the application of forces, by a human operator 110 to any part of the robot arm 68. In the present invention, additional currents are added to the previously calculated Zero-G currents and applied to the robot joints 54. The additional currents are responsive and substantially proportional to any displacements of the robot joint 54 from its initial rest position. As a consequence, the further the robot arm 68 is displaced from its resting position, the greater the current applied to, and torque delivered from, each robot joint 54. The increased torque output from each robot joint 54 acts in a direction opposite to the displacement of the robot arm forcing it back toward its rest position. FIG. 13B shows the robot arm 68 returning to its rest position after being released by the operator 110. When the operator releases the arm, it will slowly and gently return to its initial rest position. FIG. 14 is a flow chart for the control algorithm used by the control computer 52 to affect the above described operation. Upon initiation of idle mode, the rest position of each robot joint 54 is recorded. This rest position is the position of the robot arm at the instant idle mode is initiated. Next, the required Zero G currents are calculated. The Zero G currents, when applied to the motors 80 in the robot joints 54, will provide the precise amount of current required to keep the robot arm 68 in balance against gravity. Next, the position of each robot joint 54 is successively read from the control board 72 within each robot joint 54. The amount of torque to be applied to each joint 54 is computed by subtracting each joint's current position from that joint's rest position and multiplying the result by a small scaling factor. When the operator 110 removes the force from the robot, the current applied to each joint 54 will cause it to begin to move toward the robot arm's 68 rest position. As the robot arm 68 moves closer to its rest position the applied current in excess of the zero G current is decreased, until the point where it is again equal to the Zero G current, and the robot arm has returned to the rest position. In the preferred embodiment of the invention, the idle position can be re-established by pressing and releasing the “Release Arm” switch 130 on the robot handle 60.

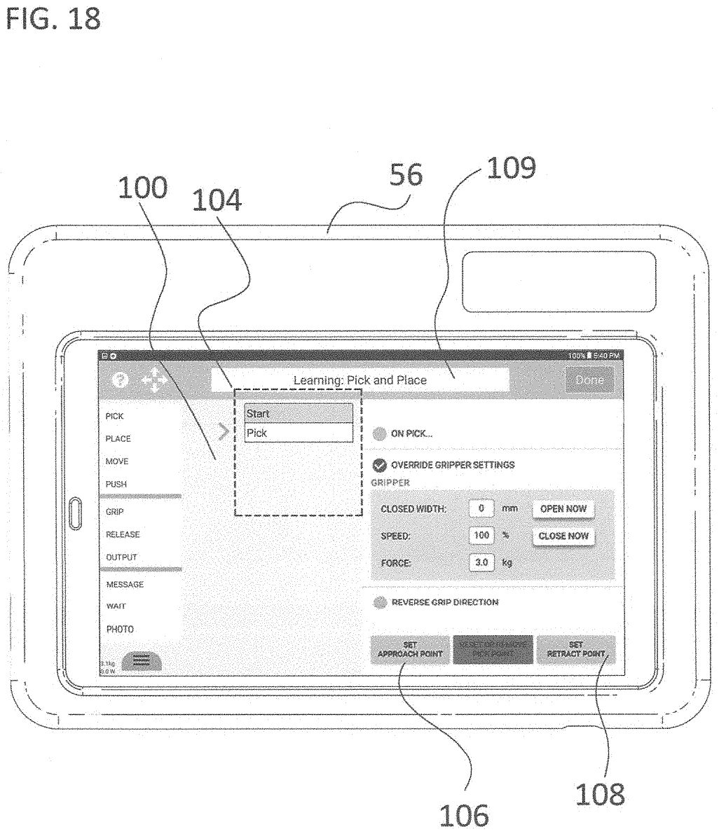

FIG. 15 shows a human operator manipulating the robot arm 68 according to the preferred embodiment of the invention. “Release Arm” switches 130 are located on four sides of the control handle 60 and are raised such that any normal gripping of the handle 60 will depress one of the switches. While the preferred embodiment of the invention employs four switches either of which release the robot arm 68, it is understood that only one switch is required. While any one of the release arm switches 130 is depressed, Zero-Gravity currents are continuously computed and applied to all joints 54 of the robot arm 68, as described previously. In this condition, the robot arm 68 moves freely and easily when manipulated by the human operator 110. Controls 130, 132, 134, 136, located on the control handle 60, allow opening or closing the gripper 64 or activating the vacuum on a vacuum gripper, or releasing the vacuum on a vacuum gripper, and signaling the robot computer 52 that the robot arm 68 is in a position to be used for planning its movement path. Robot program learning is initiated by tapping the “learn” button 94 on the home screen 92 of the control tablet 56. The robot program name 109 may optionally be entered at the top of the “learn” screen 100. Once learning is initiated as shown by the presence of the learn screen 100, the manipulations of the robot arm 68 and end-effector 64 by the human operator are evaluated and interpreted to create the robot program 104. FIG. 18 shows the “learn” screen 100 and the robot program 104 under construction in response to the manipulations of the robot arm 68 and actuations of the controls 130, 132, 134, 136 on the control handle 60 (FIG. 16).

A typical robot program 104 and teaching sequence will now be described. Most robot arm 68 applications include the positioning of objects. Typical applications involving positioning include, but are not limited to, packing products into cartons, loading and unloading machines, assembling combinations of objects, and moving products from one machine or station to another. In all such applications, the robot arm 68 must pick up an object. This operation is known to those ordinarily skilled in the art as a “Pick” operation. Similarly, in all such applications the robot arm 68 must place the object at the intended destination. This operation is known to those ordinarily skilled in the art as a “Place” operation. Between the pick location, and the place location the robot arm 68 will travel through a route which in some cases is pre-defined. In the current embodiment the human robot operator 110 manipulates the robot arm 68, and actuates the end effector gripper 64, by depressing controls 130, 132, 134, 136 on the control handle 60, at the locations and in the sequence desired by the human operator 110.

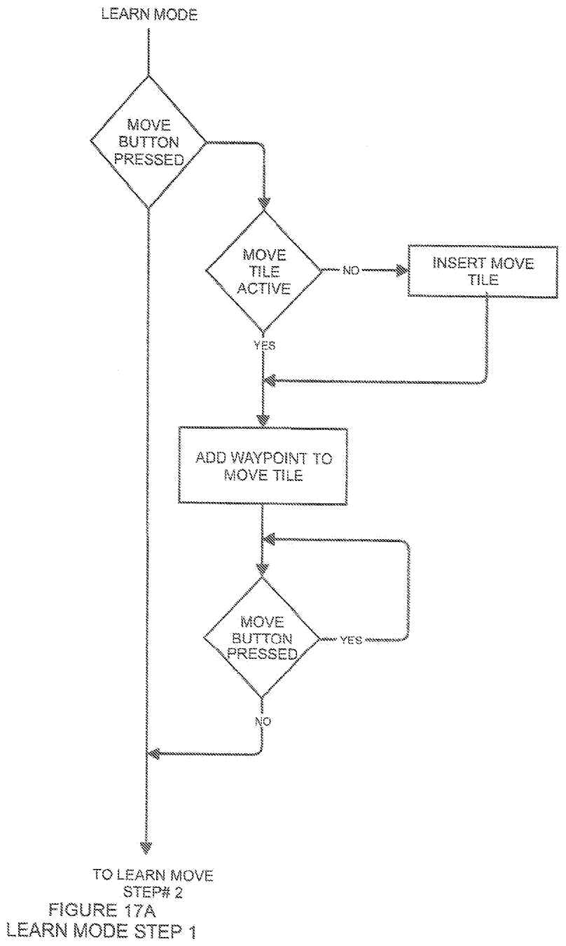

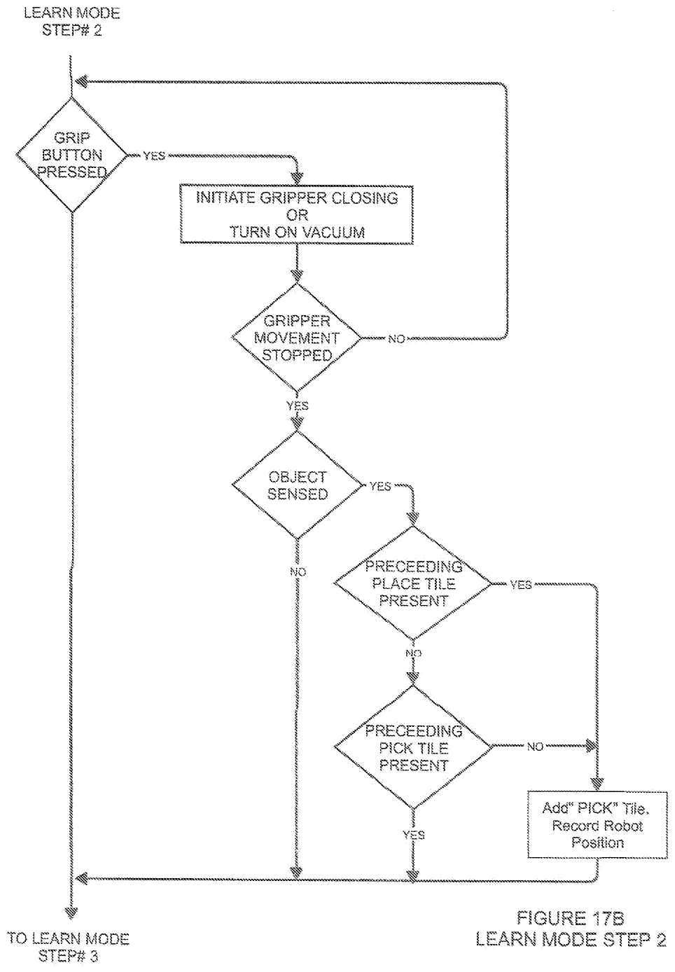

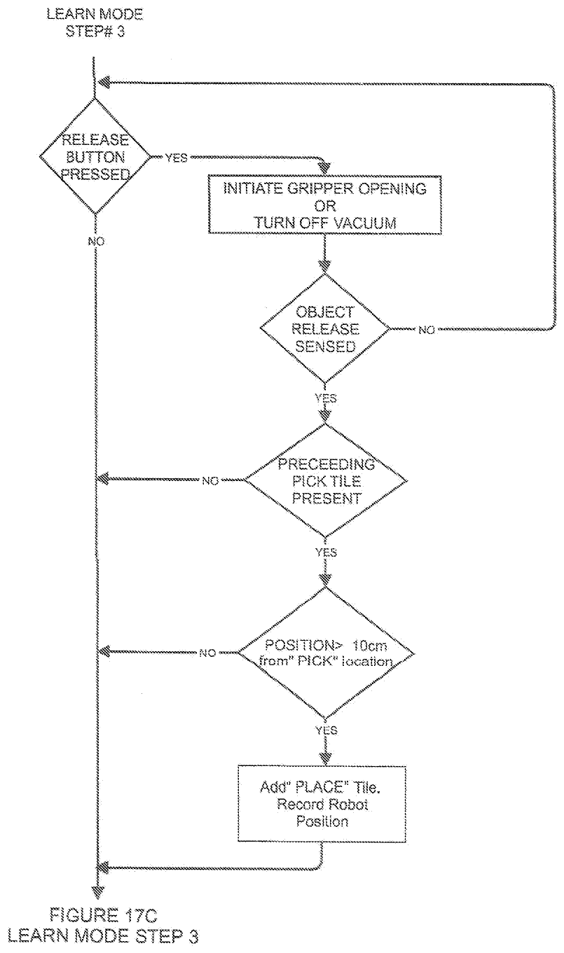

As described previously, the current embodiment represents robot programs as a sequence of “tiles” 104, displayed on the robot control tablet 56. The process of automatic construction of the robot program 104, referred to as learning, is described in the flowchart in FIGS. 17A, 17B and 17C. The human operator 110 manipulates the robot arm 68 to the position required to pick up the desired object using the robot gripper 64. Precise adjustment of this position can be made using the tapping controls as previously described and shown in FIG. 11, or the tablet rotations as previously described and shown in FIGS. 8 and 9. When the robot arm has been positioned as needed, the gripper 64 is closed, or vacuum actuated, on the object to be picked up, by depressing button 132. Sensors in the gripper 64, detect when the gripper has acquired the object. The robot control computer 52 interprets the receipt of this signal as a successful “Pick” operation and inserts a “pick” tile at the current location within the robot program 104. At the time the pick tile is inserted, the rotational positions of the joints 54 in the robot arm 68 are recorded. Additionally, the rotational positions of the joints 54 required to position the gripper 64 directly above the previously recorded pick position are computed. This location is referred to as the “approach” position. When the robot program 104 executes, the end effector 64 will pass through this “approach” position, in a direction directly toward the pickup position. In the current embodiment, the default approach position is located 100 mm directly above the pick position. Similarly, a default “retract” position is calculated, which is initially located in the same position as the approach position. While the current embodiment locates the default approach and retract positions 100 mm directly above the pick position, it is understood that different distances are often required. For example, it may be necessary to reach into a deep box which would require a longer approach trajectory. In circumstances such as this, the approach position can easily be adjusted by tapping button 106, or alternately it can be calculated based on the path of the robot arm 68 as manipulated by the human operator 110 prior to pressing the button 132 to close the gripper. The retract position can be similarly adjusted by tapping button 108, or calculating an alternative position based on the path of the robot arm 68 as manipulated by the human operator 110. While vertical approach and retract movements are appropriate and preferred for operations involving picking and placing objects for packaging, it is often necessary to program an approach trajectory from a different direction. For example, many machines require the workpiece to be inserted horizontally rather than vertically. In this case the automatically programmed approach and retract positions can be changed by positioning the robot arm at the desired approach or retract position and tapping the buttons 106 and 108 on the control tablet to change these positions.

Automatic programming of the place operation follows a similar process. When the operator presses the button 134 on the control handle 60 to open the gripper 64, or release the vacuum, sensors in the gripper or vacuum, signal the control computer 52 that the object has been released. A “place” tile is automatically inserted into the current position within the robot program 104. The identical process used in establishing the approach and retract positions for the pick operation occurs for the place operation. Following the automatic generation of the place operation, the control computer 52 computes a movement trajectory extending from the retract position of the pick operation to the approach position of the place operation. The computed movement trajectory is in a substantially straight line, or the path created by moving all of the robot arm joint 54 rotations at speeds designed to synchronize their arrival at the approach position of the place operation. In complex environments, the trajectory generated may cause collisions between the robot arm 68 and/or the object in the gripper 64, with another object in the environment. In this circumstance it is necessary to specify a trajectory that avoids the other objects in the environment. This is accomplished by signaling safe intermediate positions of the robot arm 68 located in between the pick and place locations. When the human operator 110 presses the “set position” button 136 on the control handle 60, the position of the robot joints 54 is recorded by the control computer 52. For complex environments it may be necessary to establish multiple safe positions through which the robot arm 68 travels. In response to the actuation of “set position” button 136 on the handle 60, a “move” tile is automatically inserted into the control program 104 and the position of the joints 54 comprising the robot arm 68 is recorded there in. When the robot program executes, a smooth trajectory is computed which moves the robot arm 68 from the retract position of the pick tile, through the positions stored in the move tile, and finally ending with the approach position for the place tile.

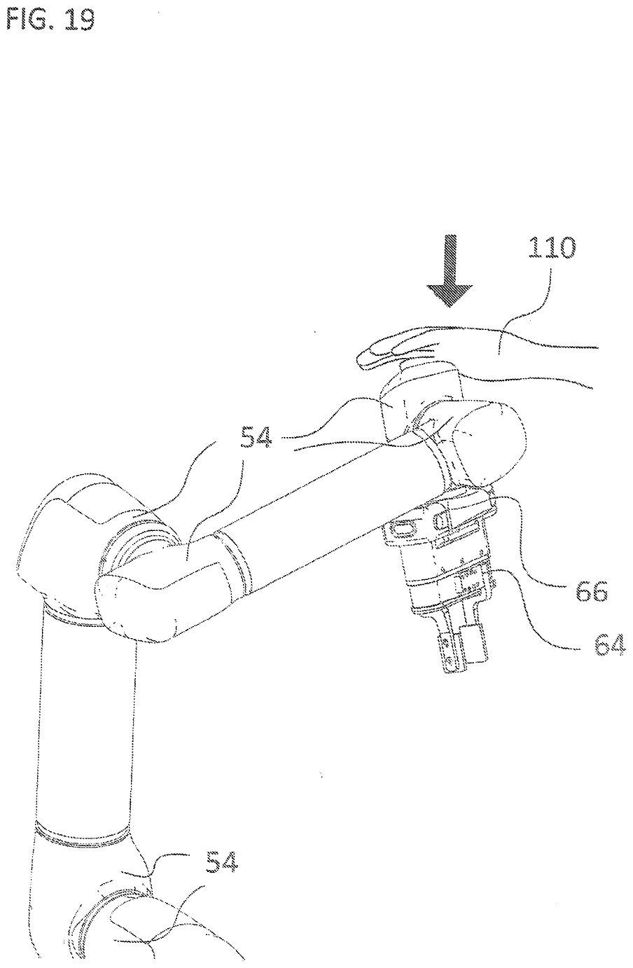

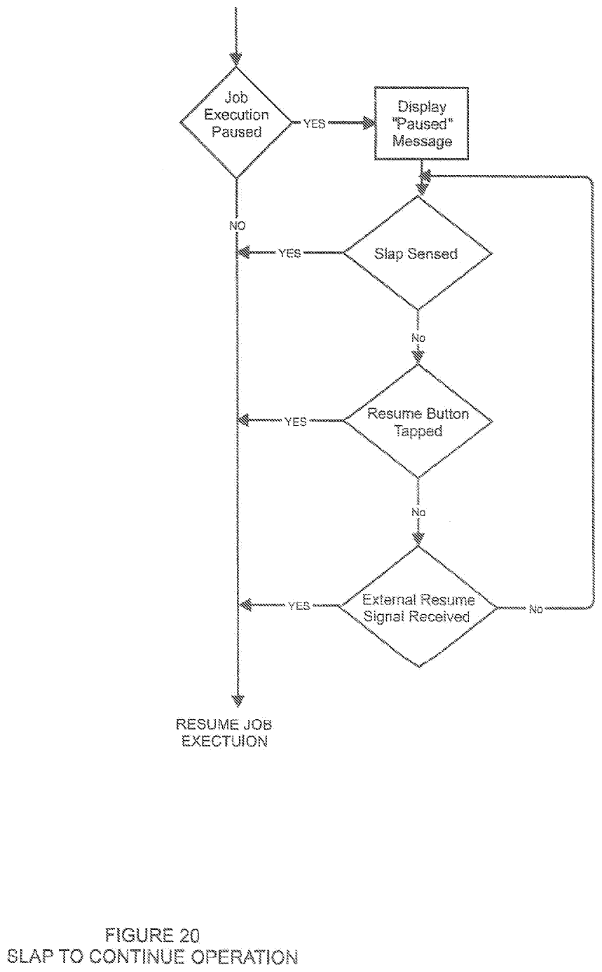

FIG. 19 shows the distal end of the robot arm, including the end effector 64 and interface devices 66. FIG. 19 depicts the robot arm being slapped by a human operator 110. A slap is defined as an impact of higher force than a tap, which was shown in FIG. 11 and described above. While executing a robot program, it is frequently necessary to pause and wait for a human operator to acknowledge that the robot may continue operation. Acknowledgement can be made by pressing a remote button (not shown), tapping an icon on the control tablet screen, or by slapping one of the robot joints 54. FIG. 20 is a flow chart of the control algorithm used by the robot computer while it is paused and waiting for acknowledgement to continue. Upon receipt of a signal from the accelerometer 76 in a joint 54, indicating the sensing of a tap, the value of the accelerations is read. If the acceleration value exceeds a threshold value, the slap has been detected. The threshold is set at a high enough level that vibrations of the joints 54 are not interpreted as an acknowledgment slap.

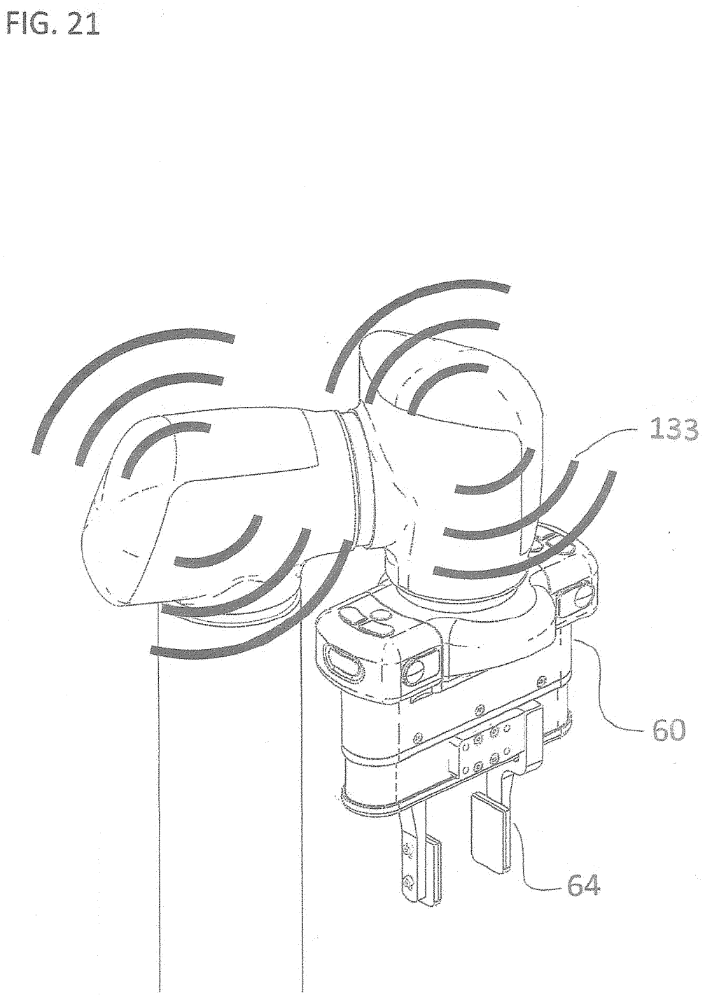

FIG. 21 depicts the robot joints 54 emitting sounds 133 in acknowledgement of the actuation of the switches on the control handle 60, various acoustical tones are generated within some joints 54 on the robot arm 68. In most cases the acoustical tones are generated within the most distal joint 54. It is understood that the tone may be generated in any joint 54 of the robot arm 68. The tone is generated by the addition of a current waveform combined with the normal operating current of the motor 80 in the joint 54 in which the tone is being generated. The amplitude of the waveform in amperes determines the volume of the tone. The frequency of the waveform determines the pitch of the tone. The frequency of the waveform must be greater than the mechanical bandwidth of the motor 80 and optional gear system 84 within the robot joint 54 in order to prevent movement. In the present invention the tone generated is in the range of 500 hz. A sine wave waveform is preferred in order to minimize any mechanical stresses the vibrations impart on the components in the robot joint 54. It is understood that alternate waveforms can be created in order to create different types of sounds.

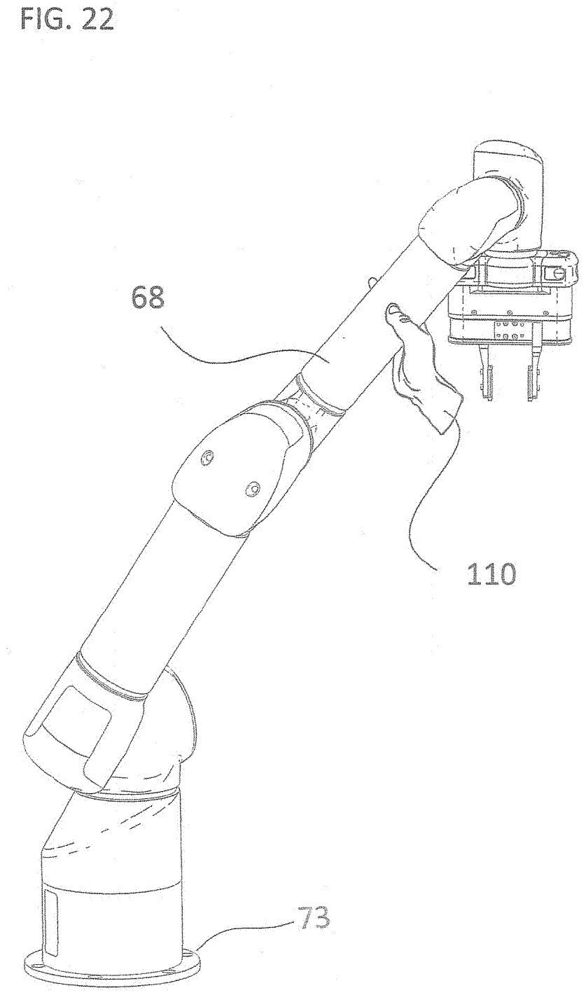

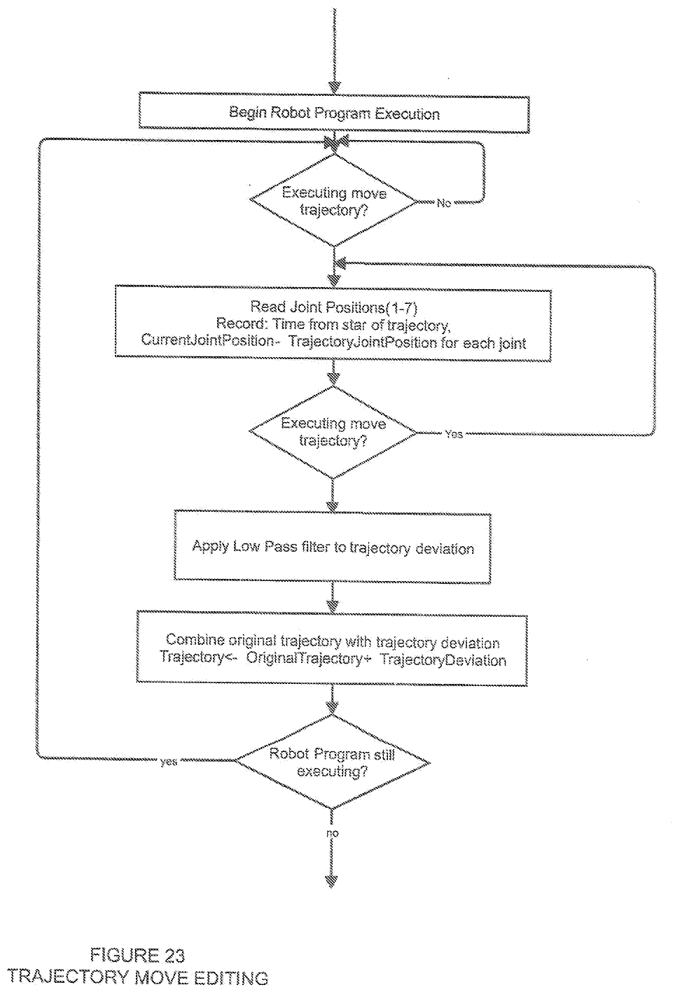

FIG. 22 shows a human operator redirecting the motion of the robot arm 68 as it moves through a previously programmed trajectory. FIG. 23 is the flowchart of the control algorithm used by the control computer 52 to modify the pre-programmed trajectory of the robot arm 68. In this mode of operation, the previously programmed robot program 104 is executed. Preferably, as the robot arm 68 begins moving through the pre-programmed trajectory, the positional gain of the servo loop controlling each joint 54 is decreased to a level which allows moderate forces to alter its adherence to the preprogrammed trajectory. Absent the application of any external forces, the trajectory of the robot arm 68 will be as previously programmed. The addition of external forces will deflect the robot arm 68 from its intended trajectory. As the robot arm progresses through its trajectory, the difference between the actual position of the robot arm 68 due to the external forces applied, and the originally programmed trajectory are recorded. The recorded trajectory deviation is added to the original robot arm trajectory and the result is re-saved as the new robot program 104. Subsequent executions of the robot program 104 will follow the newly formed trajectory. The process may be repeated an unlimited number of times.

The robot system thus far described preferably includes a base member 73 (FIG. 2) at the robot arm proximal end suitable for semi-permanent attachment on a fixed stand or table surface for long term operation. However, in accordance with a further aspect of the invention, the robot system can, alternatively, be advantageously mounted on a mobile platform for enabling it to be readily relocated, as needed, throughout a manufacturing facility.

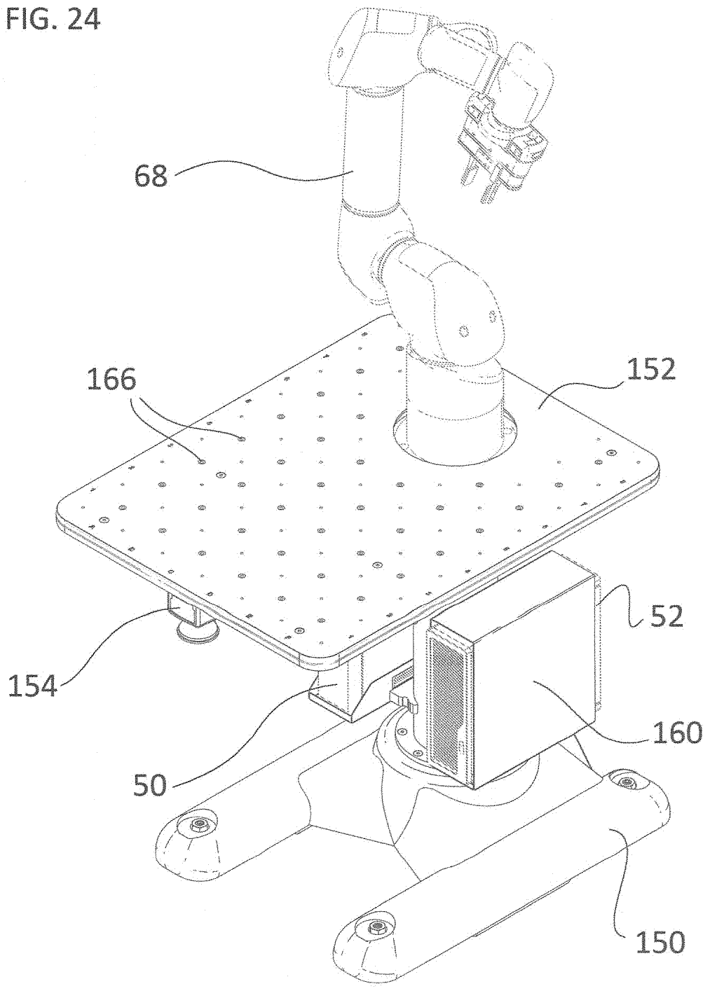

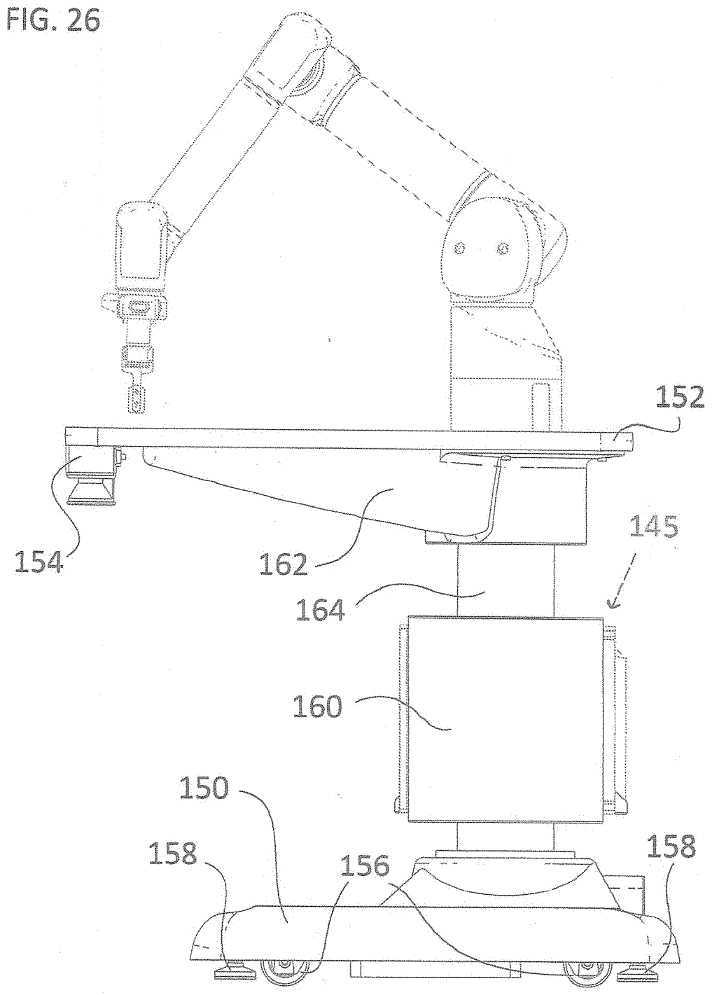

FIGS. 24-26 depict a preferred mobile platform 145 comprising a rolling stand 150 for supporting the robot arm 68 and a specially configured table 152 providing a horizontal work surface. The rolling stand 150 comprises a rigid frame supported on wheels 156. The rigid frame includes a vertical post 164 configured for attachment to the robot base member 73. The frame also includes a mounting member 162 for supporting the aforementioned work table 152 beneath the robot proximal end.

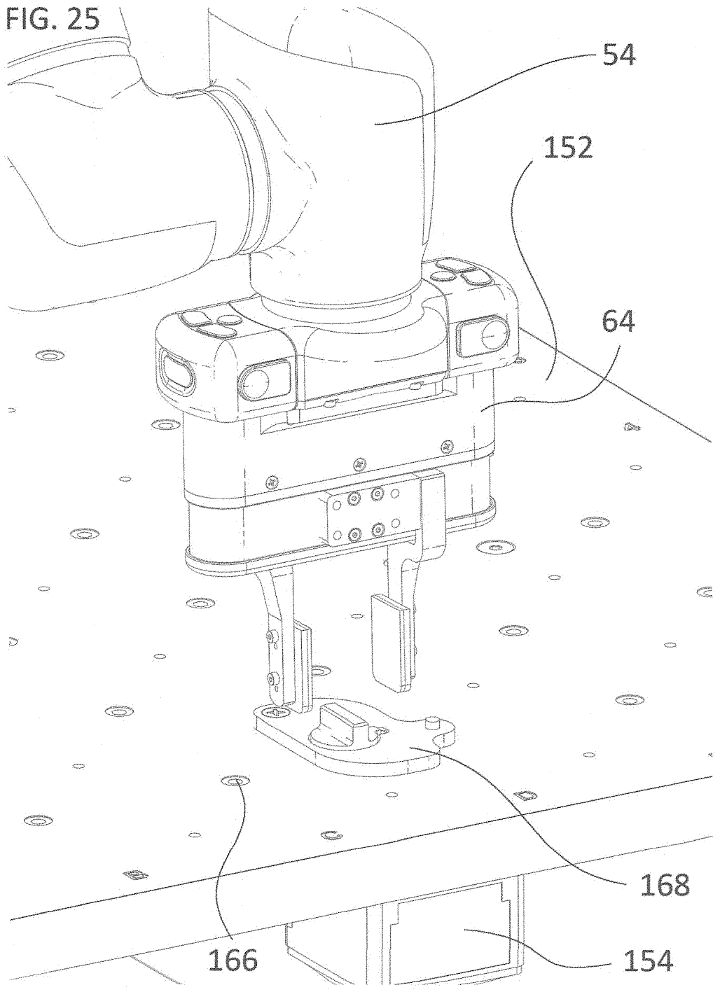

The rigid connections between the robot arm 68, the rolling stand 150, and the work table 152 allows for the entire assembly to be rolled from location to location on wheels 156. After arrival at a destination location, the wheels can be removed or raised to then support the assembly on feet 158. The rigid connections between the various structural components allows registration to be maintained between the robot arm 68 and the work table surface, relieving the need to re-register the components, or re-program the robot subsequent to it being moved. The horizontal working surface of table 152 is preferably equipped with multiple mounting points 166 for facilitating the precise mounting of various fixtures. The rolling stand preferably is equipped with one or more mounting shelves/compartments 160 for conveniently and safely accommodating electronic equipment; e.g., power supply, system computer, so that such equipment can be moved easily without disassembly. FIG. 25 also depicts an exemplary part 168 which can be handled or moved by the end effector 64 mechanism.

The horizontal working surface 152 is also preferably configured for convenient rigid coupling to additional horizontal working surfaces which can be joined in line to create an entire robotic assembly line. For safety reasons, a laser safety scanner 154 is preferably attached to the underside of the table 152 for sensing and communicating with the system computer 52 to slow or stop arm movement should any person venture within striking distance of the robot arm.

Although the foregoing text has primarily described a particular preferred embodiment of the invention, it should be recognized that multiple modifications and variations may readily occur to those skilled in the art which are expected to fall within the intended scope of the appended claims.

1. A robot system useful for selectively positioning an end effector, said system including:
an elongate robot arm comprised of multiple joint modules arranged in series including an initial module, one or more intermediate modules, and a distal module coupled to an end effector and wherein each module includes a rotary actuator member and a motor for driving said actuator member, and wherein the actuator member of each of said initial and intermediate modules is coupled to the subsequent module in said series;
a control computer coupled to said joint modules for selectively controlling the motors therein to locate and orient said end effector;
a user controlled input device operable in a learning mode to create a job program, said input device comprising a tablet configured for hand manipulation with respect to roll, pitch, and yaw axes;
at least one of said joint modules including an impact sensor for detecting a user initiated physical impact applied to said robot arm;
a communication channel responsive to the detection of a physical impact for causing said control computer to adjust said job program and responsive to said tablet manipulation for orienting said effector; and
wherein at least one of said joint modules includes a status indicator for visually displaying the operating status of that joint module.

2. The system of claim 1 wherein said impact sensor is operable to distinguish between a lower impact tap and a higher impact slap.

3. The system of claim 1 wherein said impact sensor determines the amplitude of a physical impact with respect to X, Y, and Z axes to determine a dominant axis.

4. The system of claim 3 wherein said job program includes data identifying a target position; and wherein
said control computer incrementally edits said target position data with respect to the determined dominant axis.

5. The system of claim 1 wherein said status indicator displays different colors to respectively indicate different status conditions.

6. A robot system useful for selectively positioning an end effector, said system including:
an elongate robot arm comprised of multiple joint modules arranged in series including an initial module, one or more intermediate modules, and a final module, and wherein each module includes a rotary actuator member and a motor for driving said actuator member, and wherein the actuator member of each of said initial and intermediate modules is coupled to the subsequent module in said series;
a control computer coupled to said joint modules operable in an idle state for supplying a set of currents of zero G value to said motors to maintain said robot arm in a rest position in the absence of an applied external force;
and wherein said control computer is responsive to an operator applied force displacing said robot arm to a new position for determining a modified set of currents;
and wherein said control computer is responsive to removal of said operator applied force for restoring said zero G value currents to return said robot arm to said rest position.

7. The system of claim 6 further including operator controlled means for causing said control computer to respond to said modified set of currents to establish said new position as the rest position.

8. A robot system useful for selectively positioning an end effector, said system including:
an elongate robot arm comprised of multiple joint modules arranged in series including an initial module, one or more intermediate modules, and a final module, and wherein each module includes a rotary actuator member and a motor for driving said actuator member, and wherein the actuator member of each of said initial and intermediate modules is coupled to the subsequent module in said series;
a user controlled input device operable in a learning mode to create a job program, said job program defining an initial sequence of steps for directing said robot arm along a first trajectory;
a control computer coupled to at least one of said joint module motors and responsive to said job program for causing said robot arm to execute said initial sequence of steps; and
wherein said input device comprises a hand held control tablet responsive to manual tilting with respect to roll, pitch, and yaw axes for modifying the trajectory of said robot arm.

9. A method of controlling the movement of a robot arm comprised of multiple joint modules arranged in series including an initial module, one or more intermediate modules, and a final module, and wherein each module includes a rotary actuator member and a motor for driving said actuator member, and wherein the actuator member of each of said initial and intermediate modules is coupled to the subsequent module in said series;
creating a job program defining a sequence of steps to be executed by said robot arm;
controlling said motors to execute the sequence of steps defined by said job program;
providing an impact sensor in at least one of said modules for sensing physical impacts applied to said robot arm;
editing said job program as a function of said sensed physical impacts; and
wherein said step of creating said job program includes manually tilting a handheld control tablet with respect to roll, pitch, and yaw axes.
